(19) United States
(12) Patent Application Publication
(10) Pub. No.: US 2016/0196700 A1
(43) Pub. Date: Jul. 7, 2016

(54) Universal Software Platform For Work Vehicles

(71) Applicants: Quentin GUHR, Hesston, KS (US); Christopher O'NEIL, Wichita, KS (US); Gerald JOHNSON, Hesston, KS (US); Daniel SOLDAN, Hesston, KS (US); AGCO CORPORATION, Hesston, KS (US)

(72) Inventors: Christopher B. O'Neil, Wichita, KS (US); Gerald R. Johnson, Hesston, KS (US); Daniel Soldan, Hillsboro, KS (US); Quentin Guhr, Hillsboro, KS (US)

(21) Appl. No.: 14/653,388

(22) PCT Filed: Dec. 17, 2013
(86) PCT No.: PCT/US13/75621

§ 371 Date: Jun. 18, 2015

Related U.S. Application Data
(60) Provisional application No. 61/738,484, filed on Dec. 18, 2012.

(51) Int. Cl. G07C 5/08; G05B 15/02

(52) U.S. Cl. CPC G07C 5/08; G05B 15/02; G07C 5/0808

(57) ABSTRACT

A system for maintaining the operation of a work vehicle comprises a processing element in communication with a memory element. The processing element is configured to execute software components including a device abstraction layer component, a plurality of application programming interface components, a plurality of common machine layer components, and a state manager component. The device abstraction layer component is configured to send data to and receive data from physical components of the work vehicle. The application programming interface components are configured to adjust the data. The common machine layer components are each configured to provide control and monitoring of a physical component. The state manager component is configured to monitor a state of each common machine layer component.

### CROSS REFERENCE TO RELATED APPLICATIONS

This application is a national phase application of international patent application number PCT/US2013/075621, filed Dec. 17, 2013, which claims priority to U.S. provisional application serial number 61/738484, filed Dec. 18, 2012. The full disclosures, in their entireties, of international patent application number PCT/US2013/075621 and U.S. provisional application No. 61/738,484 are hereby incorporated by reference.

### BACKGROUND OF THE INVENTION

1. Field of Invention

Embodiments of the current invention relate to software-based control systems for machinery.

2. Description of Related Art

Work vehicles and other machinery, such as agricultural machinery, often include a plurality of physical components that send and receive electrical signals or data. For example, actuators, valves, relays, and other components may require an electrical input to perform an action. In addition, sensors and other components may output a signal or a stream of data. Control systems that interface with the physical components exist but suffer from limitations.

### SUMMARY OF THE INVENTION

Embodiments of the current invention provide a distinct advance in the art of software-based control systems for machinery. More particularly, embodiments of the invention provide software-based control systems that are modular and scalable.

Embodiments of the current invention include a system for maintaining the operation of a work vehicle comprising a processing element and a memory element. The processing element is in communication with the memory element and is configured to execute software components including a device abstraction layer component, a plurality of application programming interface components, a plurality of common machine layer components, and a state manager component. The device abstraction layer component is configured to send data to and receive data from physical components of the work vehicle. The application programming interface components are in communication with the device abstraction layer and configured to adjust the data. The common machine layer components are each in communication with one application programming interface component and configured to provide control and monitoring of a physical component. The state manager component is in communication with the common machine layer components and configured to monitor a state of each common machine layer component.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a system, constructed in accordance with various embodiments of the current invention, for maintaining the operation of a work vehicle; and

FIG. 2 is a schematic block diagram of a software platform to be implemented on the system.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

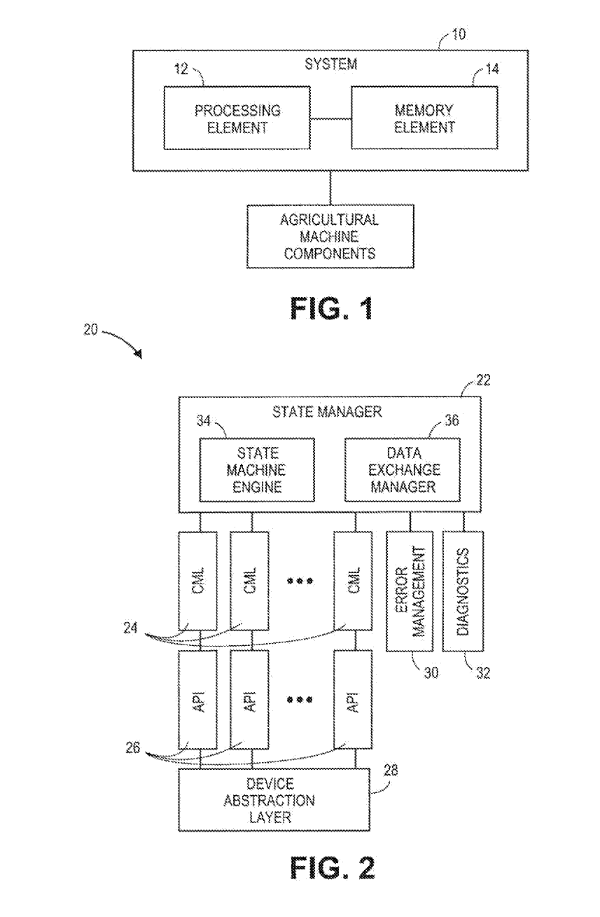

A system 10 for maintaining the operation of a work vehicle constructed in accordance with various embodiments of the current invention is shown in FIG. 1. The system 10 broadly comprises a processing element 12 and a memory element 14.

The processing element 12 may include microprocessors, microcontrollers, digital signal processors (DSPs), field-programmable gate arrays (FPGAs), analog and/or digital application-specific integrated circuits (ASICs), and the like, or combinations thereof. The processing element 12 may generally execute, process, or run instructions, code, software, firmware, programs, applications, apps, or the like, or may step through states of a finite-state machine.

The memory element 14 may include data storage components such as read-only memory (ROM), random-access memory (RAM), hard-disk drives, optical disk drives, flash memory drives, and the like, or combinations thereof. The memory element 14 may include, or may constitute, a “computer-readable storage medium”. The memory element 14 may store the instructions, code, software, firmware, programs, applications, apps, or the like that are executed by the processing element 12. The memory element 14 may also store settings or data. The memory element 14 may be in communication with the processing element 12 through one or more busses, as are known, such as address busses, data busses, control busses, and the like, which may be implemented in a parallel or serial fashion or combinations thereof.

The processing element 12 and the memory element 14 may be implemented on one or more printed circuit boards (PCBs) or in a package that is housed within the work vehicle. The processing element 12 and the memory element 14 may communicate with the components of the work vehicle through one or more vehicle busses or networks within the machine such as the controller area network (CAN) bus. Through the vehicle bus, the system 10 may transmit data, instructions, or control signals to components that require control or input, such as a motor, a valve, an actuator, or the like. In addition, the system 10 may receive data or signals from components that require monitoring, such as sensors. The memory element 14 may store data or signals that are received by the system 10. Either the system 10 or the work vehicle may further include electronic circuits such as analog-to-digital converters, digital-to-analog converters, current-to-voltage converters, amplifiers, level shifters, and the like to manage the electronic data and controls between the system 10 and the work vehicle.

The system 10 may further include a software platform 20, shown in FIG. 2, that manages the operation of the work vehicle. The software platform 20 may be stored on the computer-readable storage medium and may include a plurality of software components that provide the functional behavior of the system 10. The software components may include a state manager component 22, a plurality of common machine layer components 24, a plurality of application programming interface components 26, a device abstraction layer 28, an error management component 30, and a diagnostics component 32.

The state manager component 22 generally functions at the top level of the software platform 20 hierarchy as a manager of the activities of the common machine layer components 24 and the communication therebetween. As discussed in more detail below, each common machine layer component 24 may have a plurality of public states in which it can exist and which may have an effect on other common machine layer components 24. Each common machine layer component 24 may also have a plurality of private states which do not affect other common machine layer components 24. Unless otherwise specified, references herein to a “state” indicate a public state. The state manager component 22 ensures the common machine layer components 24 are in compatible concurrent states by having each common machine layer component 24 register with the state manager component 22 and reveal its states. If any of the common machine layer components 24 are not in compatible states, then the error management component 30 may issue an alert that an error or conflict has occurred. In this situation, it is also possible that the state manager component 22 may revert all of the common machine layer components 24 to a safe or default state.

The state manager component 22 further manages the state transitions of each common machine layer component 24. The state manager component 22 may include a state transition table that lists all of the state transitions for each common machine layer component 24. When a common machine layer component 24 needs to change states, it must request a state change from the state manager component 22 which includes a state machine engine 34 to handle the request for a state change. The state machine engine 34 may determine the current state and the future state based on the state change request and the type of common machine layer component 24 making the request. The state machine engine 34 may pass this information to the state manager component 22. In general, the state or the transition of states of one common machine layer component 24 may depend on or require that one or more of the other common machine layer components 24 be in a particular state. This data may also be stored in the state transition table. When the state manager component 22 receives the state change request and the state information, it checks the current state of all the other common machine layer components 24 and determines if any of the other common machine layer components 24 requires a state change based on the current state change request. If so, then the state manager component 22 may signal the appropriate common machine layer components 24 to change to the desired state. If the appropriate common machine layer components 24 can comply, then the state manager component 22 approves the state change request. The state machine engine 34 may receive the approval and may signal to the common machine layer component 24 that made the request to exit the current state and enter the future state. The state machine engine 34 may also update its record of the current state of the common machine layer components 24.

If any of the common machine layer components 24 cannot comply or if the state change request is invalid, then the error management component 30 may issue an alert that an error or conflict has occurred. In this situation, it is also possible that the state manager component 22 may revert all of the common machine layer components 24 to a safe or default state.

When a common machine layer component 24 requires communication with another common machine layer component 24 (generally to pass data therebetween), it makes a request to the state manager component 22 which includes a data exchange manager 36 to handle the request. The name and type of the data are sent to the data exchange manager 36 to register the data. Then, the data name and the value of the data are sent to the data exchange manager 36. The receiving common machine layer component 24 may be polling for incoming data in order to receive the data. Data exchange may occur using operating system messaging and object exchange.

The common machine layer components 24 generally provide the high-level functional control and/or monitoring necessary for the physical components of the work vehicle. In addition, there is one common machine layer component 24 for each physical component. For example, the software platform 20 may include a common machine layer component 24 for each of an engine, a thresher unit, a header unit, a cleaning unit, an autoleveling unit, a lighting unit, an unloader unit, a drive unit, and the like. The common machine layer component 24 may define its virtual behavior as a sequence of states that corresponds to the real-world behavior of the physical component. The real-world behavior may include event-driven activities, such as changing the speed or direction of the work vehicle, or time-driven activities, such as periodically monitoring the speed or location of the work vehicle. The common machine layer component 24 may transition from state to state based on factors such as inputs it receives, changes in states of other common machine layer components 24, or the like.

Each common machine layer component 24 may include three default states—“OFF”, “INIT”, and “SHUTDOWN”. OFF is the initial and final state. When the system 10 receives power (from a battery of the work vehicle), the default state is OFF. When power from the ignition of the work vehicle is detected, the common machine layer component 24 will transition to the INIT state. The state manager component 22 always allows a state change from OFF to INIT.

INIT is the next state in a power up sequence when ignition power is detected. The INIT state permits validations, diagnostic checks, and initializations as required. The next transition state is dependent on the common machine layer component 24. Transitions from the INIT state must always be requested of the state manager component 22.

The common machine layer component 24 proceeds to the SHUTDOWN state when ignition power is removed. The SHUTDOWN state allows the common machine layer component 24 to do any post processing, cleanup, data storage, and power-down execution as required by the common machine layer component 24 definition. The common machine layer component 24 will transition to the OFF state if the ignition remains off. If the ignition is turned on during the SHUTDOWN state, the common machine layer component 24 will transition to the INIT state. The state manager component 22 always allows a state change from SHUTDOWN to INIT. The power to the system 10 remains on until all common machine layer components 24 transition to the OFF state.

Transition from the current state to the future state may include an “exit” function, an “entry” function, and a “run” function as part of the common machine layer component 24 operation. When it is necessary for a common machine layer component 24 to change states, the common machine layer component 24 sends a state change request to the state manager component 22. If the state manager component 22 grants the request, then the common machine layer component 24 executes the exit function of the current state on the next task cycle (as determined by a system level clock or the like), executes the entry function of the future state on the following task cycle, and then executes the run function.

While in a state, the common machine layer component 24 may receive data or send data or commands to the work vehicle through the application programming interface components 26 and the device abstraction layer 28. The common machine layer component 24 may make decisions based on the data received or other events. If the data received requires a state change for the common machine layer component 24, then a state change request may be generated, as described above.

The application programming interface components 26 generally provide an interface with standardized data to the common machine layer components 24. Thus, each application programming interface component 26 couples with a common machine layer component 24 and may include a data source for each variable or data element that is utilized in the common machine layer component 24. The application programming interface component 26 may further include a set of functions that read data from and write data to raw data sources in the device abstraction layer 28. In order to standardize the data presented to the common machine layer component 24, the application programming interface component 26 may modify the data received through the device abstraction layer 28. For example, the common machine layer component 24 may expect a variable value to exist within a certain range of numbers. If the raw data source data is outside of the range, then the application programming interface component 26 may shift, scale, amplify, attenuate, or otherwise change the data to include values within the range.

The data sources may include at least input types and output types. The input data sources may include, but are not limited to, operator types, which may represent an input from the operator of the work vehicle such as pressing a button, adjusting a knob, changing the direction or speed of the machine, and sensor types, which represent values such as flow, position, speed, pressure, temperature, level, and angle. The output data sources may provide a command or action to a device such as a hydraulic valve, a relay, an actuator, or the like.

The device abstraction layer 28 generally communicates data to and from the physical components of the work vehicle and may include a plurality of raw data sources. As with the data sources, the raw data sources may include at least input types and output types. The raw data source inputs may include analog voltage, analog current, frequency data, and digital data. The raw data source inputs may further include data types, such as packets, from a network or bus on the work vehicle, such as the CAN bus. The raw data source outputs may include digital data, pulse width modulated data, and CAN data to other common machine layer components 24. Digital outputs are binary on and off, while PWM outputs are created by varying the width of the pulse (or duty cycle) the output signal at a predefined frequency. The width of the pulse creates a root-mean-square (RMS) output voltage, which effectively allows proportional valves to be regulated.

Each raw data source may be accessed by one or more of the data sources of the application programming interface components 26. Furthermore, the application programming interface component 26 may modify the data from the raw data source, as described above.

The error management component 30 generally handles error situations within the software platform 20. Errors may occur during a state change request as discussed above, in situations involving data transmission or reception, during diagnostic evaluation, or in other situations. The error management component 30 may evaluate the error and determine an appropriate response to alert the operator of the work vehicle such as sounding an audible alarm, flashing an error light, displaying a message on a monitor screen, or the like, or combinations thereof.

The diagnostics component 32 may generate internal diagnostic tests or may provide an interface to the system 10 for external diagnostic equipment. The diagnostics component 32 may transmit or receive data or settings and may coordinate with the state manager component 22 to place the common machine layer components 24 in a particular state or transition through a sequence of states.

The system 10 provides at least the following benefits. The modular nature of the system 10 allows for scalability both in expansion and reduction. If a physical component is added to the work vehicle, then an appropriate common machine layer component 24 and application programming interface component 26 can be added to the software platform 20 that control or monitor the behavior of the physical component. If a physical component is removed from the work vehicle, then the corresponding common machine layer component 24 and application programming interface component 26 can either be deleted from the software platform 20 or ignored during the operation of the system 10. Furthermore, if the features or behavior of a physical component change, then the parameters of only the corresponding common machine layer component 24 and application programming interface component 26 need to be modified.

The system 10 described herein has been presented with embodiments that interact with or operate with work vehicles. However, the system 10 could also be utilized with other types of machinery or vehicles, such as automobiles, construction vehicles, military vehicles, and the like.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for maintaining operation of a work vehicle, the system comprising:
a processing element in communication with a memory element and configured to execute software components including:
a device abstraction layer component configured to send data to and receive data from physical components of the work vehicle;
a plurality of application programming interface components in communication with the device abstraction layer and configured to adjust the data;
a plurality of common machine layer components each in communication with one application programming interface component and configured to provide control and monitoring of a physical component; and
a state manager component in communication with the common machine layer components and configured to monitor a state of each common machine layer component.

2. The system of claim 1, wherein each common machine layer component includes a plurality of states and the common machine layer component seeks approval from the state manager component to transition from a current state to a future state.

3. The system of claim 2, wherein the state manager component is further configured to approve the transition if the future state does not conflict with the current state of the other common machine layer components.

4. The system of claim 2, wherein the state manager component is further configured to reject the transition if the future state conflicts with the current state of any of the other common machine layer components.

5. The system of claim 1, wherein the state manager component is further configured to manage the communication of data from one common machine layer component to another common machine layer component.

6. The system of claim 1, wherein the system includes one application programming interface component and one common machine layer component for each physical component of the work vehicle.

7. The system of claim 1, wherein each common machine layer component is further configured to receive adjusted data from an application programming interface component.

8. The system of claim 1, wherein the software components further include an error management component configured to alert an operator of the work vehicle when an error occurs in the system.

9. The system of claim 1, wherein the software components further include a diagnostics component configured to interface with external diagnostics equipment.

10. A non-transitory computer-readable storage medium with an executable program stored thereon for controlling a processing element used for maintaining operation of a work vehicle, wherein the program includes the following software components:
a device abstraction layer component configured to send data to and receive data from physical components of the work vehicle;
a plurality of application programming interface components in communication with the device abstraction layer and configured to adjust the data;
a plurality of common machine layer components each in communication with one application programming interface component and configured to provide control and monitoring of a physical component; and
a state manager component in communication with the common machine layer components and configured to monitor a state of each common machine layer component.

11. The computer-readable storage medium of claim 10, wherein each common machine layer component includes a plurality of states and the common machine layer component seeks approval from the state manager component to transition from a current state to a future state.

12. The computer-readable storage medium of claim 11, wherein the state manager component is further configured to approve the transition if the future state does not conflict with the current state of the other common machine layer components.

13. The computer-readable storage medium of claim 11, wherein the state manager component is further configured to reject the transition if the future state conflicts with the current state of any of the other common machine layer components.

14. The computer-readable storage medium of claim 10, wherein the state manager component is further configured to manage the communication of data from one common machine layer component to another common machine layer component.

15. The computer-readable storage medium of claim 10, wherein the system includes one application programming interface component and one common machine layer component for each physical component of the work vehicle.

16. The computer-readable storage medium of claim 10, wherein each common machine layer component is further configured to receive adjusted data from an application programming interface component.

17. The computer-readable storage medium of claim 10, wherein the software components further include an error management component configured to alert an operator of the work vehicle when an error occurs in the system.

18. The computer-readable storage medium of claim 10, wherein the software components further include a diagnostics component configured to interface with external diagnostics equipment.
